(19) United States
(12) Patent Application Publication
(10) Pub. No.: US 2023/0359989 A1
(43) Pub. Date: Nov. 9, 2023

(54) FOODSTUFF MANAGEMENT APPARATUS, FOODSTUFF MANAGEMENT METHOD, AND FOODSTUFF MANAGEMENT PROGRAM

(71) Applicant: HITACHI, LTD., Tokyo (JP)

(72) Inventors: Toru YASUMURA, Tokyo (JP); Keisuke HORIUCHI, Tokyo (JP); Masahiro TOYAMA, Tokyo (JP); Misato FUKAMI, Tokyo (JP); Ying ZHONG, Tokyo (JP)

(21) Appl. No.: 18/305,434

(22) Filed: Apr. 24, 2023

(30) Foreign Application Priority Data
May 9, 2022 (JP) 2022-077165

(51) Int. Cl. G06Q 10/087

(52) U.S. Cl. CPC G06Q 10/087

(57) ABSTRACT

Food waste and loss is avoided by performing accommodation of foodstuffs. A foodstuff management apparatus of the present invention includes an inventory allocation section that determines, on the basis of information to the effect that allocation of a foodstuff to a grocery store has been cancelled and a condition of the foodstuff or circumstances of other grocery store, the other grocery store to which the foodstuff can be reallocated.

### CROSS-REFERENCE TO RELATED APPLICATION

The present application claims priority from Japanese application JP2022-077165, filed on May 9, 2022, the contents of which is hereby incorporated by reference into this application.

### BACKGROUND OF THE INVENTION

### 1. Field of the Invention

The present invention relates to a foodstuff management apparatus, a foodstuff management method, and a foodstuff management program.

### 2. Description of the Related Art

In recent years, companies have been required to reduce carbon dioxide emissions in their production activities. In particular, a food service industry such as restaurants and a ready-made meal industry (take-home or home delivery grocery) such as convenience stores are required to reduce food waste and loss (food loss). In response to such a requirement, it has become commonplace for computers to manage distribution of foodstuffs.

In the wholesale method described in JP-2008-117410-A, a management server manages “merchandise that needs to be kept fresh” that is stored in an automated warehouse in a wholesale market. In transactions in the wholesale market, an owner of such merchandise transitions sequentially from wholesaler to intermediary and to retailer. The management server in question stores the owners of such merchandise in association with the merchandise while chronologically updating the owners.

### SUMMARY OF THE INVENTION

For example, there is a case where after a procurement department of a restaurant chain has purchased a foodstuff in anticipation of sales of a significant quantity of the foodstuff at a specific store of the restaurant chain, the sales of that foodstuff at that store may become impossible due to a reason of bad weather, cancellation of an event, or the like. In such a case described above, the procurement department is required to accommodate other stores with the purchased foodstuff without disposing of the foodstuff.

However, the management server described in JP-2008-117410-A does not assume that an intermediary or retailer will cancel the transaction after storing the specific intermediary or retailer as an owner of merchandise once (i.e., after allocation). That is, a separate measure is required to perform accommodation of the merchandise.

Therefore, it is an object of the present invention to avoid food waste and loss by performing accommodation of foodstuffs.

A foodstuff management apparatus of the present invention includes an inventory allocation section that determines, on the basis of information to the effect that allocation of a foodstuff to a grocery store has been cancelled and a condition of the foodstuff or circumstances of other grocery store, other grocery store to which the foodstuff can be reallocated.

In regard to the other means, descriptions will be made in the following description of the preferred embodiments.

According to the present invention, it is possible to avoid food waste and loss by performing accommodation of foodstuffs.

### BRIEF DESCRIPTION OF THE DRAWINGS

FIG. 1 is a diagram describing a flow of foodstuffs and the like;

FIG. 2 is a diagram describing a configuration and the like of a foodstuff management apparatus;

FIG. 3 is a diagram illustrating an example of inventory information;

FIG. 4 is a diagram illustrating an example of allocation information;

FIG. 5 is a diagram illustrating an example of accommodation score information; and

FIG. 6 is a flowchart of a processing procedure.

### DESCRIPTION OF THE PREFERRED EMBODIMENTS

Hereinafter, a detailed description will be given of a mode for carrying out the present invention (referred to as “the present embodiment”) with reference to diagrams and the like. The present embodiment is an example of a ready-made meal company that has a plurality of grocery stores (e.g., restaurants, convenience stores) in urban areas and a foodstuff storage facility in an urban neighborhood. However, the present invention is applicable to an example in which merchandise that needs to be kept fresh is sold in a plurality of stores. A typical example of such merchandise is foodstuffs. The “foodstuffs” of the present embodiment may be unprocessed vegetables and the like or processed (cooked) ready-made food and the like. In the present embodiment, “foodstuffs” are a broad concept that includes generally mentioned “food.”

### Flow of Foodstuffs

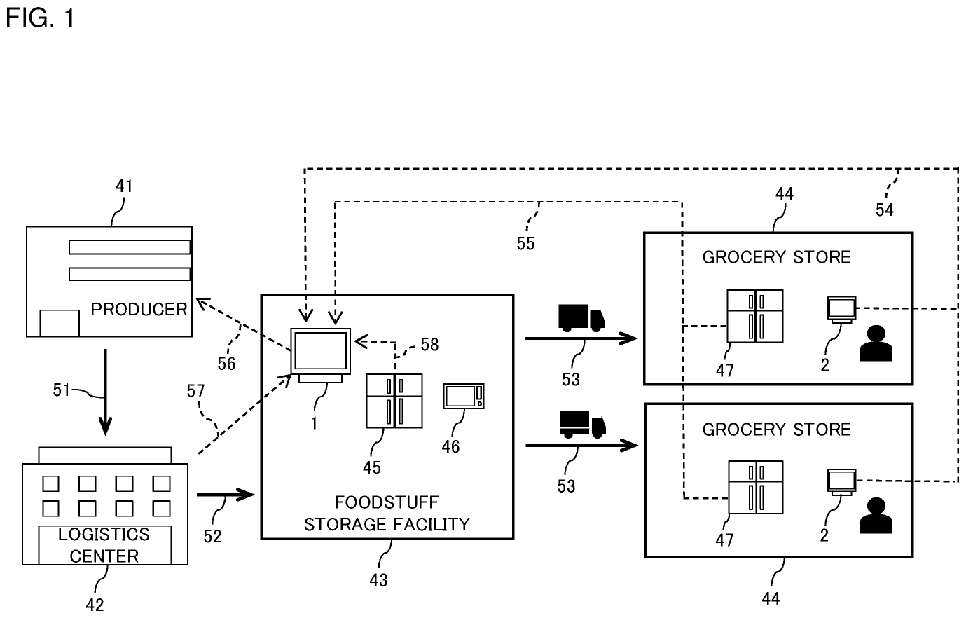

FIG. 1 is a diagram describing a flow of foodstuffs and the like. Solid arrows indicate the flow of foodstuffs, and dashed arrows indicate the flow of information. A producer 41 produces foodstuffs. A logistics center 42 receives the foodstuffs from the producer 41 (arrow 51) and delivers them to a foodstuff storage facility 43 (arrow 52). The foodstuff storage facility 43 transports the foodstuffs to each of a plurality of grocery stores 44 (arrow 53). In many cases, the grocery stores 44 are located in urban areas, and the foodstuff storage facility 43 is located in an urban neighborhood. In many cases, the foodstuff storage facility 43 and the grocery stores 44 belong to the same company. The foodstuff storage facility 43 is shared among the plurality of grocery stores 44.

The foodstuff storage facility 43 has a foodstuff management apparatus 1, a storehouse 45, and a thawing apparatus 46. The storehouse 45 is a freezing, refrigeration, and/or room temperature storehouse for storing foodstuffs. The thawing apparatus 46 thaws foodstuffs taken out from the storehouse 45, immediately before they are transported to the grocery stores. The foodstuff management apparatus 1 is a computer for managing the flow of foodstuffs (described in detail later). The foodstuff management apparatus 1 may be located at a position other than the foodstuff storage facility 43. Vehicles for transporting the foodstuffs as indicated by arrows 53 have a vehicle-mounted freezing, refrigeration, and/or room temperature storehouse.

The grocery stores 44 have a storehouse 47 and a terminal apparatus 2. The storehouses 47 are also freezing, refrigeration, and/or room temperature storehouses for storing foodstuffs. The terminal apparatuses 2 are computers operated by managers of the grocery stores 44.

Although not described in FIG. 1, the foodstuff storage facility 43 may also have, for example, a function like that of a central kitchen in a convenience store. The terminal apparatuses 2 of the grocery stores 44 transmit information regarding orders for foodstuffs to the foodstuff management apparatus 1 (arrow 54). The storehouses 47 of the grocery stores 44 include a camera for capturing images of foodstuffs present thereinside, a sensor for measuring temperature inside the storehouse, a reader for reading tags attached to the foodstuffs, and the like. The storehouses 47 transmit information for creating inventory information 31, which will be described later, to the foodstuff management apparatus 1 (arrow 55).

The storehouse 45 of the foodstuff storage facility 43 also includes a camera for capturing images of foodstuffs present thereinside, a sensor for measuring temperature inside the storehouse, a reader for reading tags attached to the foodstuffs, and the like. The storehouse 45 also transmits information for creating the inventory information 31, which will be described later, to the foodstuff management apparatus 1 (arrow 58).

The foodstuff management apparatus 1 places an order for foodstuffs with the producer 41 in response to an order for foodstuffs from the grocery stores 44 and according to an inventory quantity of foodstuffs currently stored in the storehouse 45, in order to make up for shortage of foodstuffs stored in the storehouse 45 (arrow 56). The logistics center 42 transmits information regarding foodstuffs to be transported to the foodstuff storage facility 43 to the foodstuff management apparatus 1 (arrow 57).

### Configuration and the Like of the Foodstuff Management Apparatus

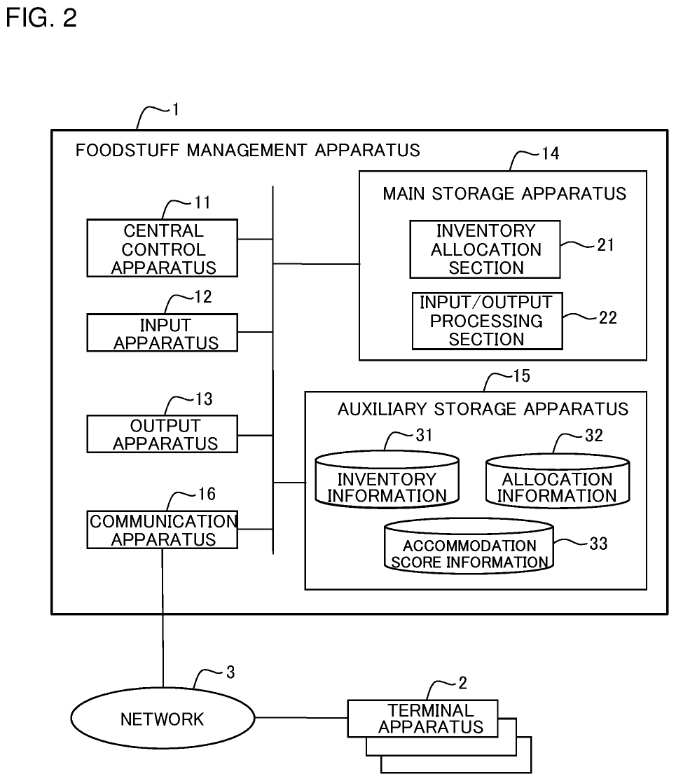

FIG. 2 is a diagram describing a configuration and the like of the foodstuff management apparatus 1. The foodstuff management apparatus 1 is a general computer and includes a central control apparatus 11, an input apparatus 12 such as mouse and keyboard, an output apparatus 13 such as display, a main storage apparatus 14, an auxiliary storage apparatus 15, and a communication apparatus 16. These are connected to each other via a bus. The auxiliary storage apparatus 15 stores the inventory information 31, allocation information 32, and accommodation score information 33 (described in detail later).

An inventory allocation section 21 and an input/output processing section 22 in the main storage apparatus 14 are programs. The central control apparatus 11 realizes functions (described in detail later) of the respective programs by reading these programs into the main storage apparatus 14 from the auxiliary storage apparatus 15. The foodstuff management apparatus 1 is connected to the terminal apparatus 2 via a wired or wireless network 3.

The terminal apparatus 2 is also a general computer and includes a central control apparatus, an input apparatus such as mouse and keyboard, an output apparatus such as display, a main storage apparatus, an auxiliary storage apparatus, and a communication apparatus (not illustrated).

### Significance of Foodstuff Accommodation

For example, it is expected that many cherry-blossom viewers gather in parks in the city center on weekends in spring. The parks themselves try to attract the cherry-blossom viewers by planning a night-time illumination and the like event. At this time, the grocery store 44 near the park places an order for a specific foodstuff (e.g., “makunouchi bento box”) with the foodstuff management apparatus 1. The foodstuff management apparatus 1 allocates, of the makunouchi bento boxes stored in the storehouse 45 of the foodstuff storage facility 43, the quantity associated with the order to the grocery store 44 near the park. Due to an impact caused by out-of-season long rainfall, however, cancellation of the event is announced just before starting of the event. Then, the grocery store 44 near the park has no other choice but to cancel the order for makunouchi bento boxes.

It should be noted that although a bento box is prepared from foodstuffs, it is treated as a foodstuff for reasons of convenience in the present embodiment. As a side note, food (processed food) has two dates, namely, “consume-by date” and “best-by date” (JAS Act, Food Sanitation Act). Of these, the “best-by date” means the “date by which the food can be eaten safely” until this “day, month, and year” in the case where it is stored by following the stated storage method without opening the bag or container and is indicated on perishable food such as bento boxes, sandwiches, raw noodles, and cakes.

Makunouchi bento boxes naturally have a best-by date. If left as they are, a large number of excess makunouchi bento boxes are generated in the storehouse 45 of the foodstuff storage facility 43. The foodstuff storage facility 43 desires to reduce food waste and loss by accommodating the other grocery stores 44 with as many makunouchi bento boxes as possible before the best-by date. In the present embodiment, performing accommodation of a foodstuff is synonymous with cancelling allocation of a foodstuff to a grocery store and then reallocating the foodstuff to other grocery stores. It should be noted that “cancellation” may or may not act as a trigger for “reallocation.”

The problem is to determine how many makunouchi bento boxes will be accommodated to which grocery stores 44. The foodstuff management apparatus 1 must ensure that the grocery stores 44 having been accommodated with the makunouchi bento boxes will increase their sales. As a prerequisite therefor, the makunouchi bento boxes that have been accommodated must be kept in ideal condition at the grocery stores 44 to which the accommodation has been performed.

### Accommodation Score and Subscore

Criteria by which the foodstuff management apparatus 1 determines how much foodstuff will be accommodated to which grocery stores 44 are, on the whole, firstly the condition of the foodstuff to be accommodated and secondly the circumstances of other grocery stores to which the foodstuff will be accommodated. The foodstuff management apparatus 1 defines, for a given foodstuff, an “accommodation score” for a combination of the grocery store 44 that is an accommodation destination and the quantity to be accommodated. The accommodation score is, for example, a weighted sum of subscore 1, subscore 2, subscore 3, and so on. Each of the subscores is an output variable of a predetermined function.

This function has, as its input variables, a specific value at the grocery store that is the accommodation destination and the quantity of foodstuff to be accommodated. An output variable of this function is an index that indicates an advantage of accommodation (reallocating) of the quantity of foodstuff to other grocery stores. In consequence, the accommodation score that is the weighted sum of these indices also becomes an index that indicates the advantage of reallocating the quantity of foodstuff to other grocery store. A large accommodation score means that the combination of the grocery store as the accommodation destination, the quantity to be accommodated, and an accommodation timing is preferred by a user of the foodstuff management apparatus 1. A concrete structure of the function varies depending on the user. The foodstuff management apparatus 1 may use a function created by the user as-is or automatically create a function by machine learning that uses past data as learning data.

The following six subscores are defined according to how the specific value is adopted.

The fewer the number of days remaining from the scheduled day of sales at the accommodation destination to the best-by date of the foodstuff in question, the more early promotion is required, and the smaller the number of boxes that can be accommodated to each grocery store. The subscore 1 is an output variable of the function that has remaining days and the quantity of foodstuff as input variables.

The larger the sum of the number of days the foodstuff in question has been stored in the foodstuff storage facility and the number of days it is scheduled to be stored at the accommodation destination, the more early promotion is required, and the smaller the number of boxes that can be accommodated to each grocery store. The subscore 2 is an output variable of the function that has this sum and the quantity of foodstuff as input variables.

The larger the time integral value of a difference between a chronological transition of a storage temperature in the foodstuff storage facility and the scheduled storage temperature at the accommodation destination and a specified temperature, the more early promotion is required, and the smaller the number of boxes that can be accommodated to each grocery store. The subscore 3 is an output variable of the function that has this time integral value and the quantity of foodstuff as input variables.

The larger the storage capability (free space) of the storehouse at the accommodation destination, the more leeway is given to promotion period, and the larger the number of boxes that can be accommodated to each grocery store. A subscore 4 is an output variable of the function that has this storage capability and the quantity of foodstuff as input variables.

The larger the foodstuff sales capability (e.g., number of customer visits, sales floor area, number of salespersons) at the accommodation destination, the larger the number of boxes that can be accommodated to each grocery store. A subscore 5 is an output variable of the function that has this sales capability and the quantity of the foodstuff as input variables.

The larger the cost for transporting the foodstuff to the accommodation destination, the smaller the number of boxes of the foodstuff that can be accommodated to the accommodation destination. A subscore 6 is an output variable of the function that has this cost and the quantity of the foodstuff as input variables.

The above subscores 1 to 3 correspond to foodstuff conditions, and the above subscores 4 to 6 correspond to circumstances of other grocery stores (accommodation destinations). However, these are merely examples, and other than those, functions having values as listed below may output subscores.
Actual order quantity of the same or a similar foodstuff at the accommodation destination
Actual accommodated quantity received by the accommodation destination
Meteorological conditions at the accommodation destination (e.g., temperature, humidity, wind speed, weather)
People's flow information near the accommodation destination (e.g., number of passengers getting off at the nearest railroad station)
Presence or absence of a wish of the accommodation destination to the effect that it desires to receive an accommodation proposal at an optional timing
Presence or absence of specification to the effect that sales at the accommodation destination in particular are desired to be increased

For example, in the case where an order for 50 boxes from a grocery store A is cancelled, the foodstuff management apparatus 1 decides to accommodate a grocery store B with 30 boxes and accommodate a grocery store C with 30 boxes. At this time, the sum of the accommodation score for accommodation of 20 boxes to the grocery store B and the accommodation score for accommodation 30 boxes to the grocery store C is the largest among all combinations of accommodation scores whose total of the quantities equals 50 boxes.

### Inventory Information

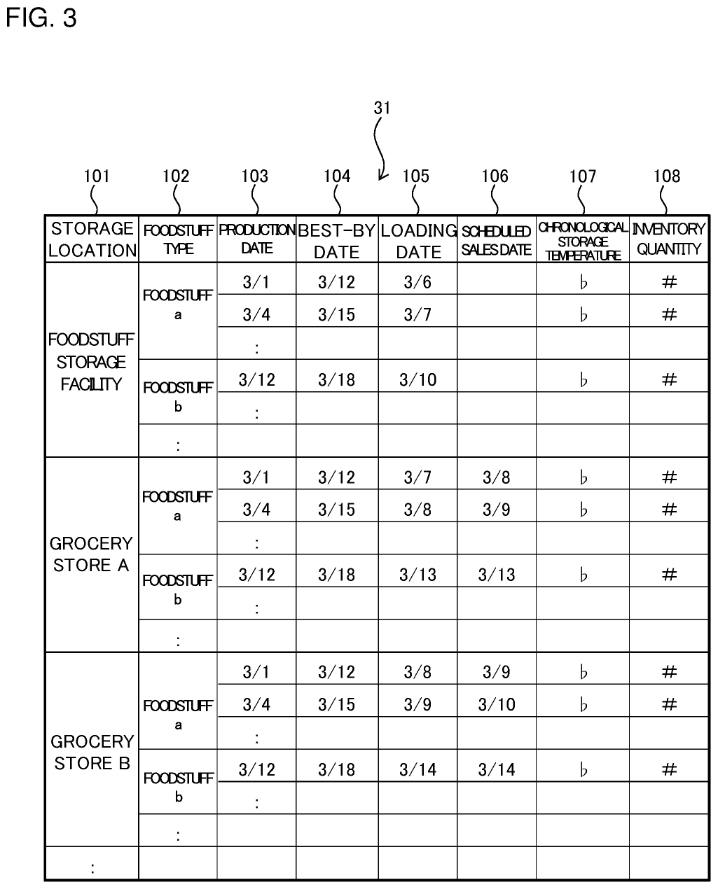

FIG. 3 is a diagram illustrating an example of inventory information 31. In the inventory information 31, a foodstuff type is stored in a foodstuff type field 102, a production date is stored in a production date field 103, a best-by date is stored in a best-by date field 104, a loading date is stored in a loading date field 105, a scheduled sales date is stored in a scheduled sales date field 106, a chronological storage temperature is stored in a chronological storage temperature field 107, and an inventory quantity is stored in an inventory quantity field 108, in association with a storage location stored in a storage location field 101.

The storage location of the storage location field 101 is a storage location of foodstuffs and is either the foodstuff storage facility 43 or one of the grocery stores 44.

The foodstuff type of the foodstuff type field 102 is a type of foodstuff.

The production date of the production date field 103 is the day and month when the foodstuff has been produced (harvested) by the producer 41.

The best-by date of the best-by date field 104 is the day and month or deadline until when the foodstuff is kept fresh and tasty.

The loading date of the loading date field 105 is the month and day when the foodstuff has been loaded into the storehouse of the storage location.

The scheduled sales date of the scheduled sales date field 106 is the month and day when the foodstuff is scheduled to be sold at the grocery store 44.

The chronological storage temperature of the chronological storage temperature field 107 is the chronological transition of the foodstuff temperature from the loading date to the current time. “♭” indicates a set of vectors “(time of day, temperature)” having a predetermined time of day and a foodstuff temperature at that time of day as its elements. For example, in the case where the predetermined time of day is “00 minute every hour” and 24 hours have elapsed from the loading date to the current time, “≡” becomes a set of 24 vectors. The foodstuff is stored at a specified temperature (freezing, refrigeration, or room temperature) suitable for itself.

The inventory quantity of the inventory quantity field 108 is the unallocated quantity of the foodstuff that is currently stored in the storehouse 45 of the foodstuff storage facility 43 or the quantity of the foodstuff that is currently stored in the storehouse 47 of each of the grocery stores 44. “#” indicates different numbers in an abbreviated manner.

### Allocation Information

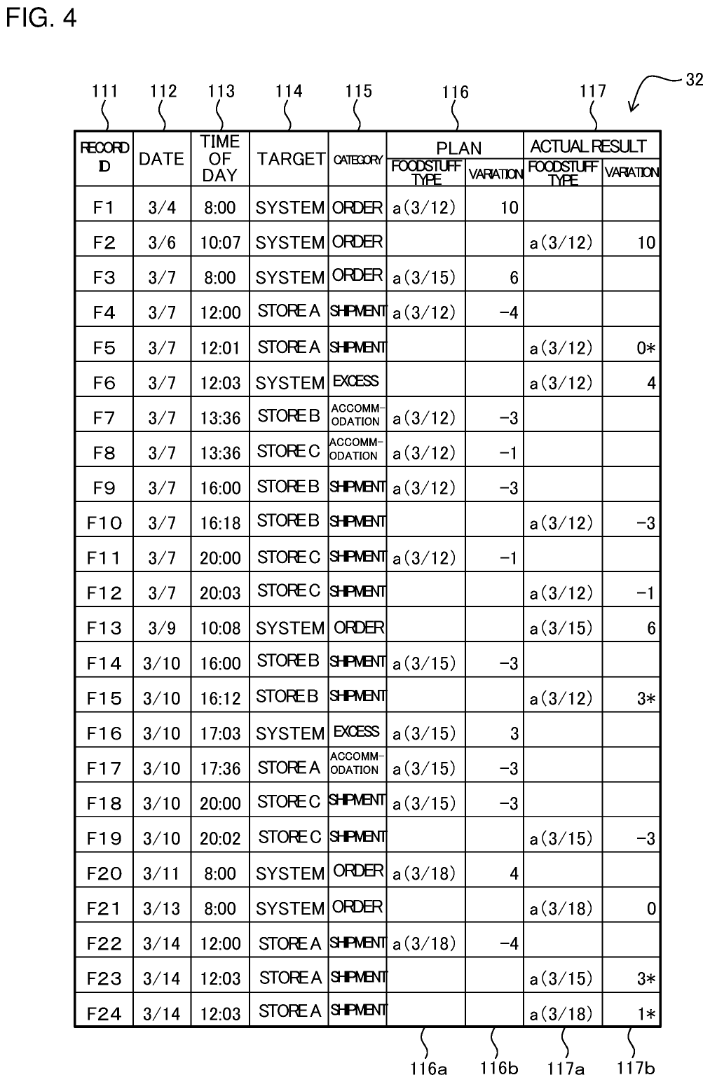

FIG. 4 is a diagram illustrating an example of the allocation information 32. In the allocation information 32, a date is stored in a date field 112, a time of day is stored in a time of day field 113, a target is stored in a target field 114, a category is stored in a category field 115, a plan is stored in a plan field 116, and an actual result is stored in an actual result field 117, in association with the record ID stored in a record ID field 111.

The record ID of the record ID field 111 is an identifier that uniquely identifies a record (row) of the allocation information 32. Each record corresponds, for example, to a flow of information indicated by the arrow 54, 56, or 57 in FIG. 1 and indicates a transition of an unallocated inventory quantity of foodstuff.

The date of the date field 112 and the time of day of the time of day field 113 are the month and day and the time of day when an order is placed or shipment is made in the case where the category is “Order” or “Shipment,” and are the month and day and the time of day when an excess is recognized or accommodation is determined in the case where the category is “Excess” or “Accommodation.”

The combination of the target of the target field 114 and the category of the category field 115 indicates movement of the foodstuff. The target is one of “System,” “Store A,” “Store B,” “Store C,” and so on. “Store A” and the like are synonymous with “Grocery store A” and the like. The category is one of “Order,” “Shipment,” “Excess,” and “Accommodation.” “Order” or “Excess” as a category corresponds to “System” as a target. “Shipment” or “Accommodation” as a category corresponds to “Store A” as a target. This is also true for “Store B,” “Store C,” and so on.

The combination of “System” and “Order” indicates that the foodstuff management apparatus 1 has placed an order for a foodstuff with the producer 41.

The combination of “System” and “Excess” indicates that an excess foodstuff has generated at the storehouse 45 of the foodstuff storage facility 43 due to cancellation of an order by the one grocery store 44, that is, a need has occurred to reallocate the foodstuff in question to one of the other grocery stores 44.

The combination of “Store A” and “Shipment” indicates that the foodstuff management apparatus 1 has allocated a foodstuff to the grocery store A due to placement of an order by the grocery store A to the foodstuff management apparatus 1 or the foodstuff management apparatus 1 has reallocated the excess foodstuff to the grocery store A due to consent of the grocery store A to the accommodation. This is also true for “Store B,” “Store C,” and so on.

The combination of “Store A” and “Accommodation” indicates that the foodstuff management apparatus 1 has allocated the excess foodstuff to the grocery store A due to cancellation of an order by the grocery store other than the grocery store A. This is also true for “Store B,” “Store C,” and so on.

The plan of the plan field 116 is the combination of a foodstuff type (field 116a) and a variation (field 116b) at a planning stage.

Of these, the foodstuff type is the same as the foodstuff type in FIG. 3. In FIG. 4, the letters “Foodstuff” in “Foodstuff a” and the like have been omitted to save space. Further, all the foodstuff types have been unified to “a” to simplify the description. Then, the month and day of the best-by date of the foodstuff is added to the foodstuff type (in brackets).

The variation is an increase or decrease in the current unallocated inventory quantity (field 108 in FIG. 3) of the foodstuff that is affected by the record. The increase or decrease is defined for the combination of a foodstuff type and its best-by date. It should be noted that an “actual result” stage exists as a concept for the “planning” stage. The difference between those will be described later.

The actual result of the actual result field 117 is the combination of the foodstuff type (field 117a) and the variation (field 117b) in the actual result stage.

Of these, the foodstuff type is the same as the foodstuff type in FIG. 3. In FIG. 4, the letters “Foodstuff” in “Foodstuff a” and the like have been omitted to save space. Further, all the foodstuff types have been unified to “a” to simplify the description. Then, the month and day of the best-by date of the foodstuff is added to the foodstuff type (in brackets).

The variation is an increase or decrease in the current unallocated inventory quantity (field 108 in FIG. 3) of the foodstuff that is affected by the record.

The increase or decrease is defined for the combination of a foodstuff type and its best-by date.

### Planning Stage and Actual Result Stage

The planning stage is a stage before a foodstuff is actually transported, and the actual result stage is a stage after the foodstuff is actually transported. Since cancellation of an order at the grocery store 44 is an exceptional fact, it is stored in the actual result field 117 irrespective of whether it occurs before or after the transport.

In a normal case where cancellation of an order does not occur, when a foodstuff is transported, the foodstuff management apparatus 1 moves the foodstuff type and the variation stored in the plan field 116 as-is to the actual result field 117 in subsequent records.

For example, the following can be found by referring to FIG. 4.

<Records F1 to F3> From 8:00 on March 4 to 8:00 on March 7, the foodstuff management apparatus 1 places orders for a total of 16 boxes of the foodstuff a with the producer 41 on two occasions. Of these, 10 boxes of the foodstuff a whose best-by date is March 12 are already transported from the logistics center 42 to the foodstuff storage facility 43.

<Record F4> At 12:00 on March 7, the foodstuff management apparatus 1 allocates four boxes of the foodstuff a to the grocery store A.

<Record F5> At 12:01 on March 7, the foodstuff management apparatus 1 accepts the cancellation of the order for the foodstuff a by the grocery store A. “0*” in the variation field 117 of the record F5 indicates that the order has been cancelled. “0” indicates the quantity of the foodstuff a received by the grocery store A (the foodstuff a is not received after all).

<Record F6> At 12:03 on March 7, the foodstuff management apparatus 1 recognizes that four boxes of the foodstuff a is an excess.

<Records F7 and F8> At 13:36 on March 7, the foodstuff management apparatus 1 calculates accommodation scores and, on the basis of the calculation result, temporarily decides to reallocate three boxes of the foodstuff a to the grocery store B and one box of the foodstuff a to the grocery store C. The category “Accommodation” indicates that the reallocation is a proposal from the foodstuff management apparatus 1 and is not based on orders from the grocery stores. Here, it is assumed, for convenience of description, that the grocery store B and the grocery store C consented to the proposal. It should be noted that, naturally, the foodstuff management apparatus 1 cancels the allocation of four boxes of the foodstuff a to the grocery store A at this stage.

<Record F9> At 16:00 on March 7, the foodstuff management apparatus 1 decides to reallocate three boxes of the foodstuff a to the grocery store B in response to the consent of the grocery store B to the proposal.

<Record F10> At 16:18 on March 7, three boxes of the foodstuff a are transported to the grocery store B.

<Record F11> At 20:00 on March 7, the foodstuff management apparatus 1 decides to reallocate one box of the foodstuff a to the grocery store C in response to the consent of the grocery store C to the proposal.

<Record F12> At 20:03 on March 7, one box of the foodstuff a is transported to the grocery store C.

Since record F13 and beyond in FIG. 4 are almost the same in content as the above ones, the detailed description thereof is omitted. It should be noted, however, that, on March 10, the foodstuff management apparatus 1 temporarily allocates three boxes of the foodstuff a whose best-by date is March 15 to the grocery store B (record F14). Immediately thereafter, three boxes of the foodstuff a whose best-by date is March 12 are mistakenly transported to the grocery store B. Unexpectedly, the grocery store B accepts all three boxes while expressing an objection (record F15, “*” indicates objection). As a result, there are three excess boxes of the foodstuff a whose best-by date is March 15 (record F16). A similar incident occurs on March 14.

### Accommodation Score Information

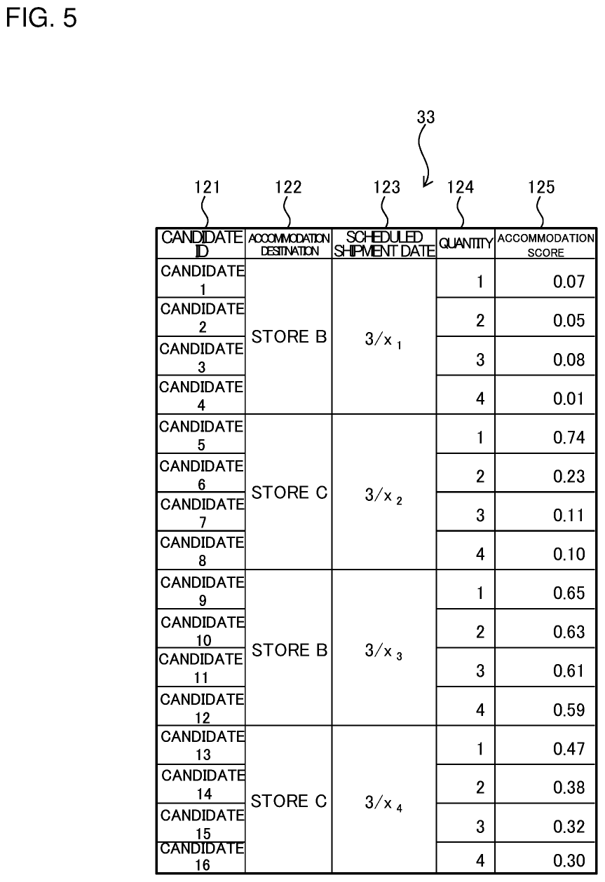

FIG. 5 is a diagram illustrating an example of the accommodation score information 33. In the accommodation score information 33, an accommodation destination is stored in an accommodation destination field 122, a scheduled shipment date is stored in a scheduled shipment date field 123, a quantity is stored in a quantity field 124, and an accommodation score is stored in an accommodation score field 125, in association with a candidate ID stored in a candidate ID field 121.

The candidate ID of the candidate ID field 121 is an identifier that uniquely identifies a candidate. The candidate is a candidate for determining “how much quantity will be accommodated to which grocery store” for a specific foodstuff, and one candidate corresponds to a record of the accommodation score information 33.

The accommodation destination of the accommodation destination field 122 is a candidate for the grocery store 44 that can be an accommodation destination. Here also, “Store B” and the like are synonymous with “Grocery store B” and the like. There is no “Store A” in the field in question in the example of FIG. 5 because FIG. 5 is one for performing accommodation of the foodstuff that has become an excess as a result of the cancellation of an order by the grocery store A to other grocery stores.

The scheduled shipment date of the scheduled shipment date field 123 is the date (field 112) of the record whose category is “Shipment” in FIG. 4.

The quantity of the quantity field 124 is the sequence (1, 2, 3, and so on up to n) of one or a plurality of natural numbers having, as a maximum value, a current excess quantity n for a specific foodstuff. The quantity n here is an excess quantity due to the cancellation of an order and differs from the inventory quantity in FIG. 3. Then, the quantity n is equal to the number of candidates corresponding to the same accommodation destination.

The accommodation score of the accommodation score field 125 is the above described accommodation score. As described above, the accommodation score is an index that indicates the advantage of reallocating a foodstuff to other grocery stores and is defined by the following formula:

Accommodation score Y=W₁×X₁+W₂×X₂+W₃×X₃+W₄×X₄+W₅×X₅+W₆×X₆

where Xₘ (m=1, 2, and so on up to 6) is a subscore. Wₘ is a weight by which Xₘ is multiplied. There is no limitation to the number of subscores (number of dimensions on the right hand side). Also, “0≤Wₘ≤1” and “W₁+W₂+W₃+W₄+W₅+W₆” hold. Further, for ease of understanding, Xₘ has been normalized within predetermined bounds (e.g., 0 or more and 1 or less).

### Processing Procedure

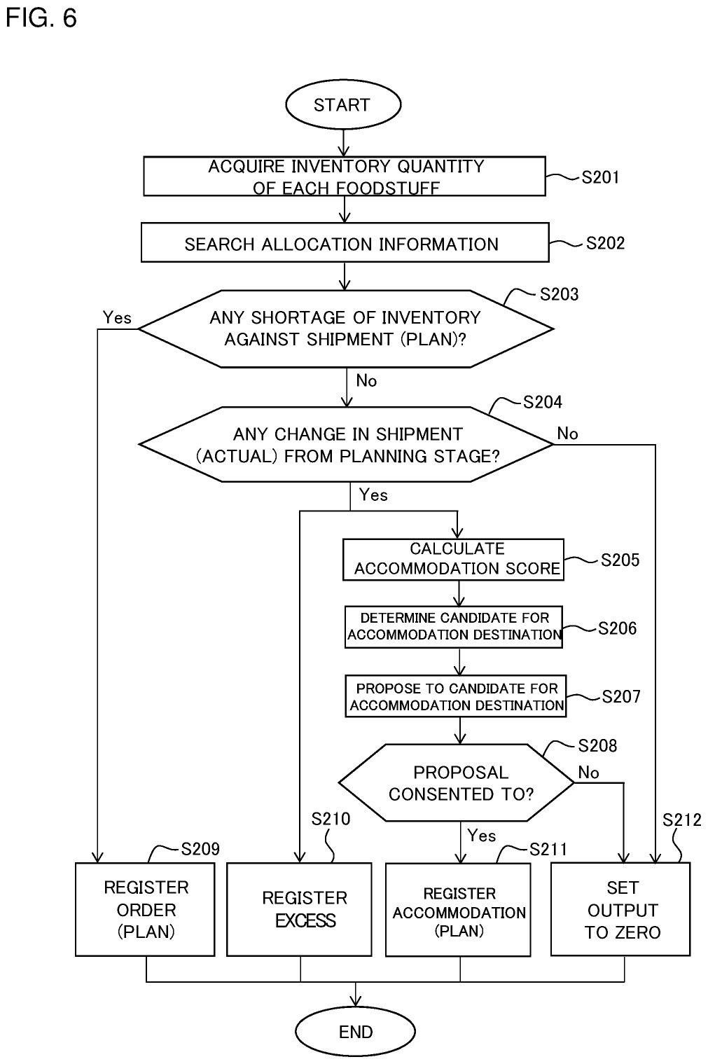

FIG. 6 is a flowchart of a processing procedure. As a prerequisite for the processing procedure to be started, it is assumed that the input/output processing section 22 of the foodstuff management apparatus 1 constantly acquires necessary information (reference signs 54, 55, 57, and 58 in FIG. 1) from the terminal apparatus 2 and the storehouses 47 of the respective grocery stores 44, the storehouse 45 of the foodstuff storage facility 43, and the logistics center 42. Further, it is assumed, on the basis of the acquired information, that the inventory allocation section 21 of the foodstuff management apparatus 1 keeps the inventory information 31 (FIG. 3) and the allocation information 32 (FIG. 4) up to date.

In step S201, the inventory allocation section 21 of the foodstuff management apparatus 1 acquires the inventory quantity of each foodstuff. Specifically, the inventory allocation section 21 refers to the inventory information 31 (FIG. 3) and acquires the unallocated inventory quantity for each foodstuff. As a result, the inventory allocation section 21 acquires as many inventory quantities as the number of types of foodstuffs. In step S202 and beyond, similar processing is performed continuously or in parallel for each foodstuff. For ease of understanding, processing for the specific “foodstuff a” will be described hereinafter.

In step S202, the inventory allocation section 21 searches the allocation information 32 (FIG. 4). Specifically, the inventory allocation section 21 acquires, of the allocation information 32 (FIG. 4), a portion regarding the foodstuff a, identifies the latest records whose category is “Shipment,” and acquires the variation (field 116b) of the record in question. The variation acquired is a negative number. In the example of FIG. 4, it is assumed that the record F4 for “Store A” is acquired.

In step S203, the inventory allocation section 21 judges whether there is any shortage of inventory against the shipment (plan). Specifically, firstly, the inventory allocation section 21 compares the inventory quantity of the foodstuff a in the inventory information 31 with an absolute value of the variation acquired in step S202. Secondly, in the case where the inventory quantity is smaller than the absolute value of the variation (“Yes” in step S203), the inventory allocation section 21 proceeds to step S209. In any other case (“No” in step S203), the inventory allocation section 21 proceeds to step S204.

In step S204, the inventory allocation section 21 judges whether there is any change in shipment (actual result) from the planning stage. Specifically, firstly, the inventory allocation section 21 acquires the record (record F5 in this case) immediately after the record identified in step S202 and compares the variation in the record F4 (field 116b) with the variation in the record F5 (field 117b).

Secondly, in the case where the two variation values are different from each other as a result of the comparison or where “*” is added in the immediately following record (“Yes” in step S204), the inventory allocation section 21 proceeds to step S205 and step S210. In any other case (“No” in step S204), the inventory allocation section 21 proceeds to step S212. In FIG. 4, the variation of the record F4 (field 116b) is “−4,” and the variation of the record F5 (field 117b) is “0*.” In consequence, the inventory allocation section 21 proceeds to step S205 and step S210.

In step S205, the inventory allocation section 21 calculates the accommodation score. Specifically, first, the inventory allocation section 21 refers to the allocation information 32 and acquires the excess quantity for the foodstuff a. In the case of the example of FIG. 4, the excess quantity is “4” (variation field 117 of the record F6 in FIG. 4).

Secondly, the inventory allocation section 21 refers to the allocation information 32 and acquires the record at the planning stage whose category is “Shipment” and whose target is other than “Store A” and whose date is a future month and day. Further, the inventory allocation section 21 temporarily stores the combinations of date and target (store name) of all the records acquired. Here, for convenience of description, it is assumed that “Store B, 3/x₁,” “Store C, 3/x₂,” “Store B, 3/x₃,” and “Store C, 3/x₄” are held. As in this example, the inventory allocation section 21 may separately hold a plurality of combinations with different dates (scheduled shipment dates) even though the accommodation destination is the same. The reason for this is that accommodation can be made to the same grocery store on a plurality of occasions.

Thirdly, the inventory allocation section 21 creates the accommodation score information 33 (FIG. 5) having 16 records. Here, “16 records” is the product of the excess quantity of “4” and the number of stores held of “4” (redundancies are also counted). At this stage, the quantity field 124 is blank.

Fourthly, the inventory allocation section 21 calculates the above accommodation score Y and completes the accommodation score information 33. For example, in the record of “Candidate 1” in FIG. 5, the inventory allocation section 21 calculates the accommodation score in the case where one box of the foodstuff a is accommodated to the “Store B.” Information necessary for calculating the above subscore Xₘ in addition to the inventory information 31 and the allocation information 32 and the predetermined weight Wₘ are stored in the auxiliary storage apparatus 15, and the inventory allocation section 21 can refer to these.

There are cases where a sufficient number of records are not accumulated in the allocation information 32. In this case, the inventory allocation section 21 may store all the grocery stores other than the grocery store A in the accommodation destination field 122 of the accommodation score information 33. The grocery stores that are scheduled to sell the foodstuff a in a near future are stored in the allocation information 32. It is highly possible that such grocery stores will consent to the accommodation.

In step S206, the inventory allocation section 21 determines candidates for the accommodation destination. Specifically, the inventory allocation section 21 acquires, of the records created in the accommodation score information 33, one or the plurality of records that satisfy the following conditions 1 to 4 and determines one or the plurality of candidates for the combination of grocery store that is an accommodation destination and quantity.

<Condition 1> The sum of the quantities matches the excess quantity of “4.”

<Condition 2> The sum of the accommodation scores is maximum.

<Condition 3> No overlapping stores that are accommodation destinations (option)

<Condition 4> The period from the first scheduled shipment date to the last scheduled shipment date is equal to or less than a predetermined threshold (option)

In the example of FIG. 5, the candidate for accommodation of “3” boxes to the record “Store B, 3/x₁” and the candidate for accommodation of “1” box to the record “Store C, 3/x₂” are determined.

In step S207, the inventory allocation section 21 makes a proposal to the candidates for accommodation destinations. Specifically, the inventory allocation section 21 asks the grocery store B, by an optional method such as e-mail, whether to consent to the proposal of “accommodation of three boxes of the foodstuff a.” The inventory allocation section 21 also asks the grocery store C, by an optional method, whether to consent to the proposal of “accommodation of one box of the foodstuff a.” Since the grocery store B and the grocery store C have already placed an order for the foodstuff a on their own will, it is highly possible that they will consent to additional accommodation of the foodstuff a.

In step S208, the inventory allocation section 21 judges whether the proposal has been consented to. Specifically, in the case where at least one of answers from the grocery store B and from the grocery store C is “Consent” (“Yes” in step S208), the inventory allocation section 21 proceeds to step S211. In any other case (“No” in step S208), the inventory allocation section 21 proceeds to step S212.

In step S209, the inventory allocation section 21 registers an order (plan). Specifically, the inventory allocation section 21 newly creates and stores a record whose target is “System” and whose category is “Order” in the allocation information 32 (FIG. 4). This record is for placing an order for the foodstuff a to the producer 41 to make up for the shortage of the inventory quantity (e.g., record F1 in FIG. 4).

In step S210, the inventory allocation section 21 registers an excess. Specifically, the inventory allocation section 21 newly creates and stores a record whose target is “System” and whose category is “Excess” in the allocation information 32 (FIG. 4) (e.g., record F6 in FIG. 4).

In step S211, the inventory allocation section 21 registers accommodation (plan). Specifically, the inventory allocation section 21 newly creates and stores a record whose target is “Store B” and/or “Store C” and whose category is “Accommodation” in the allocation information 32 (FIG. 4) (e.g., record F7 and/or record F8 in FIG. 4).

In step S212, the inventory allocation section 21 sets the output to zero. Specifically, the inventory allocation section 21 decides not to create a new record in the allocation information 32 (FIG. 4).

The processing procedure ends after step S209, S210, S211, or S212. It should be noted that the processing branches into two paths after “Yes” in step S204. In consequence, the inventory allocation section 21 waits for the processing procedure to end until other steps end without ending the processing procedure immediately after any one of step S210, S211, and S212 ends earlier.

### Modification Example 1

In step S207, the inventory allocation section 21 may propose a foodstuff storage method to other grocery stores that are accommodation destinations. For example, the inventory allocation section 21 may propose a chronological storage temperature of the foodstuff a (field 107 in FIG. 3) to the grocery store B and the grocery store C.

Also, the inventory allocation section 21 may propose a foodstuff transport method to other grocery stores that are accommodation destinations. For example, the inventory allocation section 21 may propose a chronological storage temperature of the foodstuff a to the foodstuff storage facility 43 or to vehicles that transport the foodstuff a to the grocery store B and/or the grocery store C. Further, in the case where there is a difference between the storage temperature at the foodstuff storage facility 43 and the storage temperature desired by each of the grocery stores 44, the inventory allocation section 21 may propose, to the vehicles, a change of the storage temperature during transport. Further, in the case where the storage temperature at the foodstuff storage facility 43 is lower than the storage temperature desired by each of the grocery stores 44, the inventory allocation section 21 may propose, to the foodstuff storage facility 43, thawing of the foodstuff before transport to the grocery stores 44 or may propose, to the vehicles, thawing of the foodstuff during transport.

### Modification Example 2

The inventory allocation section 21 predicts a point in time when the inventory quantity reaches a first local minimum value after a current time, by constantly monitoring the inventory information 31 (FIG. 3) and acquiring a past chronological transition of the inventory quantity (field 108) for each foodstuff of the same type. Further, the inventory allocation section 21 predicts the difference between the local minimum value in question and a next local minimum value. The inventory allocation section 21 places an order with the producer 41 for the quantity of the foodstuff equivalent to the difference.

Reduction of food waste and loss contributes to target 12.3 “by 2030, halve per capita global food waste at the retail and consumer levels and reduce food losses along production and supply chains, including post-harvest losses” and target 12.5 “by 2030, substantially reduce waste generation through prevention, reduction, recycling, and reuse” in SDGs.

### Advantageous Effects of the Present Embodiment

The advantageous effects of the foodstuff management apparatus of the present embodiment are as follows:
(1) The foodstuff management apparatus can reallocate a foodstuff for which an order has been cancelled by a grocery store to other grocery stores.
(2) The foodstuff management apparatus can accurately determine grocery stores to which the foodstuff will be reallocated by calculating accommodation scores.
(3) The foodstuff management apparatus can realistically calculate accommodation scores on the basis of best-by dates and the like.
(4) The foodstuff management apparatus can realistically calculate accommodation scores on the basis of the foodstuff storage capability and the like of the grocery stores.
(5) The foodstuff management apparatus can propose a foodstuff storage temperature and the like.
(6) The foodstuff management apparatus can propose thawing and the like of foodstuffs.
(7) The foodstuff management apparatus can predict a point in time when a foodstuff inventory shortage occurs and place an order with a producer for the foodstuff.
(8) The foodstuff management apparatus enables accommodation of foodstuffs performed between the plurality of grocery stores due to the foodstuff storage facility.

It should be noted that the present invention is not limited to the above embodiment and includes various modification examples. For example, the above embodiment has been described in detail for ease of understanding the present invention, and is not necessarily limited to that which includes all the constituent elements described. Also, some of the constituent elements of one embodiment can be replaced by constituent elements of other embodiment, and constituent elements of other embodiment can be added to constituent elements of one embodiment. Also, regarding some constituent elements of each of the embodiments, addition of other constituent element, deletion, and replacement are possible.

Also, some or all of the above constituent elements, functions, processing sections, processing means, and the like may be realized, for example, by hardware by designing them with integrated circuits. Also, the above constituent elements, functions, and the like may be realized by software by a processor interpreting programs each of which realizes one of the functions. Information such as programs, tables, and files for realizing the respective functions can be placed on a recording apparatus such as memory, hard disk, or SSD (Solid State Drive) or a recording medium such as IC card, SD card, or DVD.

Also, control lines and information lines that are considered necessary for description are illustrated, and not necessarily all the control lines and information lines on a product are illustrated. It may be considered that almost all constituent elements are actually connected to each other.

What is claimed is:

1. A foodstuff management apparatus comprising:
an inventory allocation section that determines, on a basis of information to the effect that allocation of a foodstuff to a grocery store has been cancelled and a condition of the foodstuff or circumstances of other grocery store, the other grocery store to which the foodstuff can be reallocated.

2. The foodstuff management apparatus of claim 1, wherein
the inventory allocation section
calculates an accommodation score that indicates an advantage of reallocating, on the basis of the condition of the foodstuff and the circumstances of the other grocery store, the foodstuff to the other grocery store, and
determines, on a basis of the accommodation score calculated, the other grocery store to which the foodstuff can be reallocated.

3. The foodstuff management apparatus of claim 2, wherein
the condition of the foodstuff includes
at least one of a best-by date of the foodstuff, number of days for which the foodstuff has been stored, and a transition of a storage temperature of the foodstuff.

4. The foodstuff management apparatus of claim 3, wherein
the circumstances of the other grocery store include
at least one of foodstuff storage capability, foodstuff sales capability, and a cost for transporting the foodstuff to the other grocery store in question.

5. The foodstuff management apparatus of claim 4, wherein
the inventory allocation section proposes
a storage method of the foodstuff to the other grocery store.

6. The foodstuff management apparatus of claim 5, wherein
the inventory allocation section proposes
a method of transporting the reallocated foodstuff to the other grocery store.

7. The foodstuff management apparatus of claim 6, wherein
the inventory allocation section
predicts a point in time when shortage of a foodstuff to be transported to the grocery store occurs at a foodstuff storage facility that stores the foodstuff and
places an order for the foodstuff with a producer at the point in time in question.

8. The foodstuff management apparatus of claim 7, wherein
the foodstuff storage facility is
shared among a plurality of the grocery stores.

9. A foodstuff management method comprising:
determining, by an inventory allocation section of
a foodstuff management apparatus, on a basis of information to the effect that allocation of a foodstuff to a grocery store has been cancelled and a condition of the foodstuff or circumstances of other grocery store, the other grocery store to which the foodstuff can be reallocated.

10. A foodstuff management program comprising:
functioning, by a computer, as an inventory allocation section that determines, on a basis of information to the effect that allocation of a foodstuff to a grocery store has been cancelled and a condition of the foodstuff or circumstances of other grocery store, the other grocery store to which the foodstuff can be reallocated.
